(19) United States
(12) Patent Application Publication
(10) Pub. No.: US 2011/0236536 A1
(43) Pub. Date: Sep. 29, 2011

(54) METHOD AND COMPOSITION FOR LONG LASTING FLAVOR DELIVERY SYSTEM

(75) Inventor: Gagan Mongia, Glen Allen, VA (US)

(73) Assignee: Philip Morris USA Inc., Richmond, VA (US)

(21) Appl. No.: 13/071,843

(22) Filed: Mar. 25, 2011

Related U.S. Application Data
(60) Provisional application No. 61/318,200, filed on Mar. 26, 2010.

(51) Int. Cl. A23L 1/22; A23P 1/04

(52) U.S. Cl. 426/89; 426/650; 426/295

(57) ABSTRACT

A flavor gradient capsule having concentric shells with flavor increasing from outside to inside, to balance desensitization of flavor receptors during a slow dissolution in the mouth. The capsule has a core with a concentrated flavorant, an inner shell substantially surrounding the core with the same flavorant at a lower concentration, and an outer shell substantially surrounding the inner shell, with the same flavorant at a yet lower concentration. Also disclosed are methods of making such flavor gradient capsules and orally-enjoyable products incorporating the same.

### CROSS REFERENCE TO RELATED APPLICATION

This application claims priority under 35 U.S.C. §119(e) to U.S. Provisional Application No. 61/318,200, filed on Mar. 26, 2010, the entire content of which is incorporated herein by reference thereto.

### BACKGROUND

A need exists for long-lasting flavor delivery in oral sensorial products, especially when the products are meant for consumption by a slow dissolution and/or extraction process in the mouth.

### SUMMARY

In one embodiment, a method of preparing an edible flavor gradient capsule is provided, the method comprising the steps of coating a core comprising a concentrated flavorant with an inner shell comprising the same flavorant at a lower concentration than exists in the core; and subsequently coating the inner shell with an outer shell comprising the same flavorant at a lower concentration than exists in the inner shell, to form a flavor gradient capsule.

In another embodiment, a flavor gradient capsule is provided, comprising a core comprising a concentrated flavorant; an inner shell substantially surrounding the core, comprising the same flavorant at a lower concentration than exists in the core; and an outer shell substantially surrounding the inner shell, comprising the same flavorant at a lower concentration than exists in the inner shell.

In yet another embodiment, an orally-enjoyable product is provided, comprising at least one flavor gradient capsule.

### BRIEF DESCRIPTION OF THE FIGURES

FIG. 1A is a schematic illustration of an exemplary flavor gradient capsule as described herein, wherein the capsule has a core and two coating layers. FIG. 1B is a schematic illustration of another exemplary flavor gradient capsule as described herein, wherein the capsule has a core and three coating layers.

### DETAILED DESCRIPTION

Primary factors affecting the duration of perceived flavors of orally enjoyable products include the concentration of the flavor in the oral cavity and the ability of the consumer to perceive the flavor at that concentration.

The ability of a consumer to perceive a particular flavor concentration (while varying among individuals) changes depending on previous exposure, which results in a degree of desensitization. Namely, recent past exposure to a flavor tends to increase the threshold of perception so that a higher concentration of flavor becomes required in order to be perceivable.

As a complicating factor, exposure to high concentrations of flavor can result in a negative flavor experience, presenting itself in the form of harshness, bitterness, burning, and/or pain. However, due to desensitization, concentrations that might result in a negative experience if presented initially may in fact provide a positive experience if presented following exposure to lower concentrations. Indeed, after desensitization, such high concentrations may be required in order for a flavor to continue to be perceivable by the consumer.

To address these issues, described herein is a delivery system that sequentially releases a flavor compound to provide for long lasting flavor delivery.

Preferably, the system takes the form of a flavor gradient capsule suitable for use as a flavor-providing ingredient. More preferably, the capsule is not suitable for use as a confection due to high concentration of flavoring.

As used herein, the term “orally enjoyable” denotes the ability of a material or product to be enjoyed and at least partially consumed via the mouth. An orally enjoyable product can take the form of a tablet, stick, chewable gum, spongy material, foam, cream, pellet, or fiber, or a form suitable to be contained in a pouch, or combinations of these. Examples of orally enjoyable products include chewable or non-chewable edible forms, including tablets, candies, gums, chocolates, flavored sponges, pouched products, lozenges, flavor strips, and the like. Further examples of orally enjoyable products include tobacco-free pouchless or pouched products, and smokeless tobacco including chewing tobacco, tobacco pouch products, and the like.

As used herein, the term “about” when used in conjunction with a stated numerical value or range has the meaning reasonably ascribed to it by a person skilled in the art, i.e. denoting somewhat more or somewhat less than the stated value or range, to within a range of ±10% of the stated value.

### The Coating(s)

The edible flavor gradient capsule is preferably prepared by using a coating process including pan coating, fluidized bed coating, and the like. Preferably, the edible flavor gradient capsule is coated using a pan coating process.

The capsule preferably has a rounded form and contains a central core surrounded by two or more shells (also called coating layers). Each shell applied by the coating process preferably substantially surrounds the preceding shell. The core and shells of the capsule are preferably made of sugars, gums, and/or polyols.

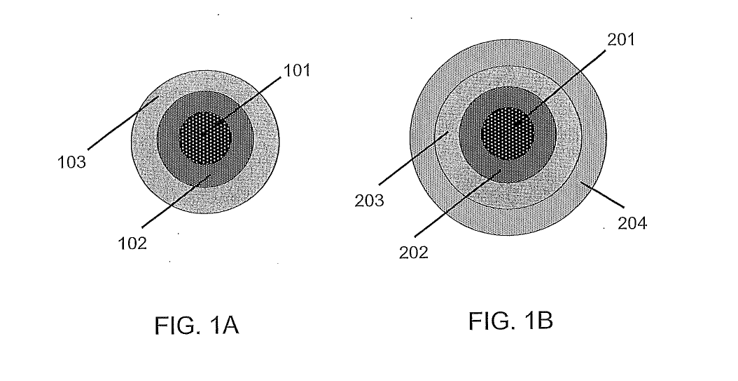

FIG. 1A illustrates schematically an exemplary flavor gradient capsule as described herein, wherein the capsule has a core 101, an inner shell 102, and an outer shell 103. FIG. 1B is a schematic illustration of another exemplary flavor gradient capsule as described herein, a core 201, a first shell 202, a second shell 203, and a third shell 204.

Preferably, the resulting capsule has a mass of less than one gram, more preferably less than 500 mg, even more preferably less than 200 mg.

### The Flavor(s)

The edible flavor gradient capsule preferably includes one flavorant which decreases in concentration in succession from the core to each shell moving from the interior to the exterior of the capsule. Thus, the core will have the highest concentration of flavorant, the innermost shell the second highest concentration, and so on.

Exemplary flavorants include, but are not limited to, berry flavors such as pomegranate, acai, raspberry, blueberry, strawberry, boysenberry, and/or cranberry. Other suitable flavorants include, without limitation, any natural or synthetic flavor or aroma, such as menthol, peppermint, spearmint, wintergreen, bourbon, scotch, whiskey, cognac, hydrangea, lavender, chocolate, licorice, citrus and other fruit flavors, such as apple, peach, pear, cherry, plum, orange, lime, grape, and grapefruit, gamma octalactone, vanillin, ethyl vanillin, breath freshener flavors, butter, rum, coconut, almond, pecan, walnut, hazelnut, french vanilla, macadamia, sugar cane, maple, cassis, caramel, banana, malt, espresso, kahlua, white chocolate, spice flavors such as cinnamon, clove, cilantro, basil, oregano, garlic, mustard, nutmeg, rosemary, thyme, tarragon, dill, sage, anise, and fennel, methyl salicylate, linalool, jasmine, coffee, olive oil, sesame oil, sunflower oil, bergamot oil, geranium oil, lemon oil, ginger oil, balsamic vinegar, rice wine vinegar, and red wine vinegar. Preferred flavors include cinnamol, tymool, and/or tea tree.

The exact amounts of flavors in the core and each shell may be varied depending on the intended use of the flavor capsule, and may be easily determined without undue experimentation.

In an embodiment, the concentrated flavorant is present in the core in an amount sufficient to cause harshness, bitterness, burning, and/or pain in the absence of prior exposure to the same flavorant at the lower concentration. As described herein, “prior exposure” means exposure in an amount sufficient and within a time period recently sufficient so as to result in desensitization to the flavorant. In another embodiment, the amount of flavorant in the inner or outer shell is not sufficient to cause harshness, bitterness, burning, and/or pain in the absence of prior exposure to same flavorant.

It will be understood that the foregoing description is of the preferred embodiments, and it, therefore, merely representative of the articles and methods of manufacturing the same. It can be appreciated that variations and modifications of the different embodiments in light of the above teachings will be readily apparent to those skilled in the art. Accordingly, the exemplary embodiments, as well as alternative embodiments, may be made without departing from the spirit and scope of the articles and methods as set forth in the attached claims. Any references mentioned herein are incorporated by reference into this disclosure in their entirety.

What is claimed is:

1. A method of preparing an edible flavor gradient capsule, comprising the steps of:
coating a core comprising a concentrated flavorant with an inner shell comprising the same flavorant at a lower concentration than exists in the core; and
subsequently coating the inner shell with an outer shell comprising the same flavorant at a lower concentration than exists in the inner shell, to form a flavor gradient capsule.

2. The method of claim 1, wherein the concentrated flavorant is present in an amount sufficient to cause harshness, bitterness, burning, and/or pain in the absence of prior exposure to the same flavorant at the lower concentration.

3. The method of claim 1, further comprising successively coating the outer shell with one or more additional shells, wherein each successive shell comprises a lower concentration of said flavorant than the preceding shell.

4. The method of claim 3, wherein a total number of shells is at least five.

5. The method of claim 4, wherein a total number of shells is at least ten.

6. The method of claim 1, wherein the flavorant in the inner shell or outer shell is not present in an amount sufficient to cause harshness, bitterness, burning, and/or pain in the absence of prior exposure to the same flavorant at lower concentration.

7. The method of claim 1, wherein said core and shells comprise a substance selected from the group consisting of sugars, gums, and polyols.

8. The method of claim 1, wherein said flavor gradient capsule has a mass of less than one gram.

9. The method of claim 1, wherein said flavor gradient capsule has a mass of less than 200 mg.

10. The method of claim 1, wherein at least one of said coating steps comprises pan coating.

11. An edible flavor gradient capsule, comprising:
a core comprising a concentrated flavorant;
an inner shell substantially surrounding the core, comprising the same flavorant at a lower concentration than exists in the core; and
an outer shell substantially surrounding the inner shell, comprising the same flavorant at a lower concentration than exists in the inner shell.

12. The edible flavor gradient capsule of claim 11, wherein the concentrated flavorant is present in an amount sufficient to cause harshness, bitterness, burning, and/or pain in the absence of prior exposure to the same flavorant at the lower concentration.

13. The edible flavor gradient capsule of claim 11,
further comprising one or more additional shells, each of which surrounds a preceding shell and comprises a concentration of said flavorant which is lower than that of the preceding shell.

14. The edible flavor gradient capsule of claim 13, wherein a total number of shells is at least five.

15. The edible flavor gradient capsule of claim 14, wherein a total number of shells is at least ten.

16. The edible flavor gradient capsule of claim 11, wherein said core and shells comprise a substance selected from the group consisting of sugars, gums, and polyols.

17. The edible flavor gradient capsule of claim 11, wherein said flavor gradient capsule has a mass of less than one gram.

18. The edible flavor gradient capsule of claim 17, wherein said flavor gradient capsule has a mass of less than 500 mg.

19. The edible flavor gradient capsule of claim 18, wherein said flavor gradient capsule has a mass of less than 200 mg.

20. An orally-enjoyable product comprising at least one flavor gradient capsule according to claim 11.
